(19) United States
(12) Patent Application Publication
(10) Pub. No.: US 2003/0230404 A1
(43) Pub. Date: Dec. 18, 2003

(54) Heat exchanger arrangement

(76) Inventors: Jesko Herrmann, Beuren (DE); Walter Blaschke, Esslingen (DE)

Correspondence Address: McGLEW AND TUTTLE, P.C., SCARBOROUGH STATION, SCARBOROUGH, NY, 10510-0827, US

(21) Appl. No.: 10/442,912

(22) Filed: May 21, 2003

(30) Foreign Application Priority Data
Jun. 12, 2002 (DE) 102 26 081.8

(51) Int. Cl. F28F 1/00; G05D 23/00

(52) U.S. Cl. 165/287; 165/41; 165/905

(57) ABSTRACT

A heat exchanger arrangement, especially for a vehicle heater, has a fluid flow space (30) surrounded by a housing arrangement (26, 28) as well as a temperature sensor arrangement (34) for detecting a variable related to the temperature of a fluid flowing through the fluid flow space (30). The temperature arrangement (34) includes at least one temperature sensor (36, 38), which is at least partially embedded in the material of a housing element (28) forming at least one part of the housing arrangement (26, 28).

### FIELD OF THE INVENTION

The present invention pertains to a heat exchanger arrangement, especially for a vehicle heater, comprising a fluid flow space surrounded by a housing arrangement as well as a temperature sensor arrangement for detecting a variable that is related to the temperature of a fluid flowing through the fluid flow space.

### BACKGROUND OF THE INVENTION

For operating a heater, as is used, e.g., as a parking heater or auxiliary heater in a motor vehicle, it is important to obtain information on the medium to be heated in order to increase the heat output when the medium temperature is too low and to reduce it when the medium temperature is too high. It is known in this connection that the temperature of the medium is determined in the area in which the thermal energy generated in a heating burner is transferred to the medium. Temperature sensors are introduced for this purpose into a heat exchanger arrangement, and openings or holes, into which the temperature sensors are then inserted with the use of sealing elements, are present for this purpose in housing elements of the heat exchanger arrangement. Besides the problem of ensuring a tight closure, the additional integration of the temperature sensors in such housing elements is an operation that increases the overall costs of such a heat exchanger arrangement and also that of a heater.

### SUMMARY OF THE INVENTION

The object of the present invention is to provide a heat exchanger arrangement that can be built in a simple manner and at low cost and in which the possibility of detecting the temperature of a fluid flowing through it is created.

This object is accomplished according to the present invention by a heat exchanger arrangement, especially for a vehicle heater, comprising a fluid flow space surrounded by a housing arrangement as well as a temperature sensor arrangement for detecting a variable that is related to the temperature of a fluid flowing through the fluid flow space, wherein the temperature sensor arrangement comprises at least one temperature sensor, which is embedded at least partially into the material of a housing element that forms at least one part of the housing arrangement.

It is essential in the heat exchanger arrangement according to the present invention that at least one temperature sensor is directly embedded into the material of a heat exchanger housing element, so that it is not necessary, on the one hand, to provide an opening which is completely continuous toward the outside and will subsequently accommodate the temperature sensor in the area in which such a temperature sensor is present. Tightness problems can thus be ruled out essentially completely. The integration can also be performed at the same time during the manufacture of this housing element, so that operations to be performed later are not necessary.

Provisions may be made, e.g., for the temperature sensor, of which there is at least one, to be completely surrounded by the material of the housing element. To make it possible to obtain information on the temperature of the fluid flowing through the fluid flow space in certain areas, it is proposed that the temperature sensor, of which there is at least one, have a detection section protruding into the fluid flow space.

In an especially preferred embodiment, the housing element is made of a plastic material, e.g., fiber-reinforced polyamide or polypropylene. Even in the liquid state, such a material has a temperature that is still insufficient to bring about damage to the embedded temperature sensor.

Provisions may be made, e.g., for the housing element to be a pot-shaped heat exchanger housing limiting the fluid flow space on the outside. Furthermore, it is possible for the housing element to be a housing element intended for the integration of a heater. The housing element carrying the at least one temperature sensor embedded in it may be, e.g., a housing element of a vehicle air conditioner or of a vehicle fan, which is already designed such that an additional vehicle heater or a heat exchanger arrangement for such a heater can be inserted at least partially into this housing element, which is already provided or is to be provided on the vehicle.

Furthermore, the present invention pertains to a vehicle heater with a heat exchanger arrangement according to the present invention.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 is a longitudinal sectional view of a heat exchanger arrangement according to the present invention or of a heater equipped with same; and

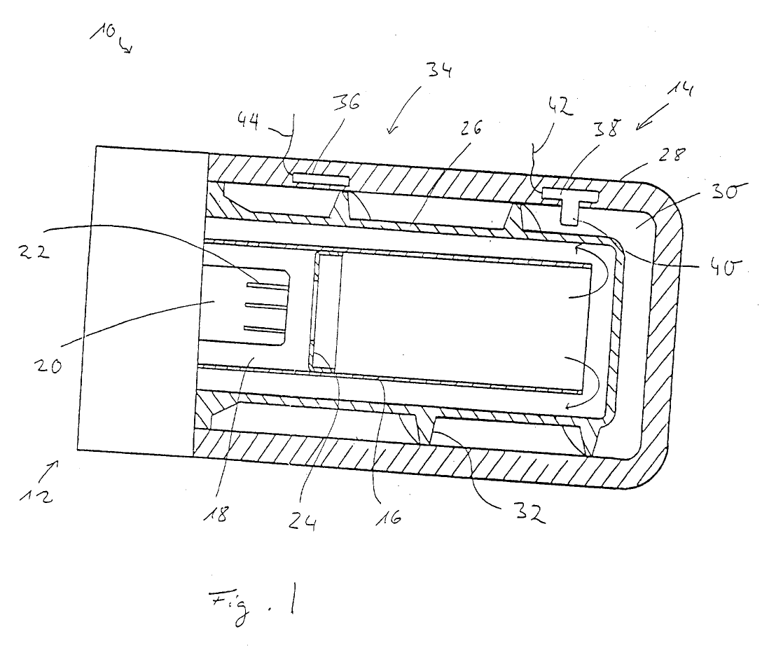

FIG. 2 is a vehicle heater system using the heater of FIG. 1.

### DESCRIPTION OF THE PREFERRED EMBODIMENT

Referring to the drawing in particular, a heater 10 is shown, which can be used, e.g., as a parking heater or auxiliary heater in a motor vehicle. The heater 10 comprises essentially two areas, namely, a heating burner area 12 and a heat exchanger area 14. The heating burner 12 area, which is indicated essentially only schematically, comprises, e.g., a combustion air blower, a fuel feed and all the components associated therewith. Furthermore, the heating burner comprises a combustion chamber 18, which is provided in a partial section of a flame tube 16 and in which a combustion air feed pipe 20 with a plurality of combustion air inlet slots 22 is provided centrally. The combustion air enters the combustion chamber 18 through the air inlet slots 22 and is burned there with the fuel likewise fed into the combustion chamber, e.g., via a porous material. Together with the combustion waste gases, the combustion flame enters the remaining area of the flame tube 16 through a flame diaphragm 24. The flame tube 16 is open at its axial free end, so that the combustion waste gases meet the heat exchanger 14 there and are deflected and flow back again on the outside of the flame tube 16 and are then released via an outlet, not shown.

It shall be pointed out here that the design of the heating burner and of the components provided for the combustion are shown here only schematically. It is obvious that a great variety of other arrangements may be used here.

The heat exchanger 14 comprises two housing parts, which are inserted one into the other and define a fluid flow space 30 between them. A heat exchanger inner housing 26 defines the space area intended for the flow of the combustion waste gases toward the inside and also forms at the same time the component by which the waste gases leaving the flame tube 16 are axially deflected. The heat exchanger outer housing 28 defines the fluid flow space 30 toward the outside and is tightly connected to the heat exchanger inner housing 26 in an axial end area, namely, the end area located close to the heating burner 12, for the fluid-tight closure of the fluid flow space 30. A rib configuration 32 of helical design, which ensures that the fluid flowing through the fluid flow space 30, e.g., water to be heated or air to be heated, moves through the fluid flow space 30 in a defined manner and can thus absorb the heat transferred by the combustion waste gases to the heat exchanger inner housing 26 in a highly efficient manner, is provided on the outer circumference of the heat exchanger inner housing.

To make it possible to control the operation of the heater 10, it is advantageous to obtain information on the temperature of the fluid to be heated or also of the fluid already heated. It is known that a temperature sensor arrangement may be provided for this purpose, and a temperature sensor may be arranged, e.g., close to the fluid inlet into the fluid flow space 30, and the other temperature sensor may be arranged close to the fluid outlet. It is thus possible to determine the extent to which heat has been transferred to the fluid being heated. The heat exchanger 14 shown in the figure also comprises two temperature sensors 36, 38, whose positioning at the heat exchanger 14 is shown as an example only. These two temperature sensors 36, 38 could, of course, be positioned in other areas as well. It is significant that according to the principles of the present invention, the temperature sensors 36, 38 are embedded at least partially into the material forming the heat exchanger outer housing 28. The temperature sensor 36 is completely surrounded by the material of the heat exchanger outer housing 28. Only the electric contacting line 44 leads through the material of the heat exchanger outer housing 28 to the outside. The temperature sensor 36 is otherwise completely encapsulated by the material of the heat exchanger outer housing 28. It is recognized above all that no opening, through which leakage could occur, is present on the surface of the heat exchanger outer housing 28 defining the fluid flow space 30 in the area of the temperature sensor 36.

The temperature sensor 38 is designed such that it projects from the heat exchanger outer housing 28 and protrudes into the fluid flow space 30 with its temperature detection section 40. It is thus possible to detect, e.g., the fluid temperature close to the surface of the heat exchanger inner housing 26 with this temperature sensor 38 or optionally to detect the temperature of the heat exchanger inner housing 26 by directly contacting the surface of the heat exchanger inner housing 26 and thus to provide information for a possible recognition of overheating. However, a tight closure of the heat exchanger outer housing 28 is otherwise provided in the area of the temperature sensor 38. Only the electric contacting line 42 is led out of the material of the heat exchanger outer housing 28 to the outside here as well.

The essential advantage of the design according to the present invention, in which temperature sensors 36, 38 of the temperature sensor arrangement 34 are embedded at least partially directly into the material of the heat exchanger outer housing 28, i.e., they are also sealed in by this material during the manufacture, is that no additional operations need to be carried out to prepare openings for sensors and no operations are likewise necessary for the subsequent mounting of temperature sensors. Furthermore, fluid leakage problems can be ruled out practically completely. It proved to be advantageous for the heat exchanger outer housing to be made of a plastic material, e.g., fiber-reinforced polyamide or polypropylene. An essential advantage is in this connection that this material is in a liquid state at comparatively low temperatures, so that a temperature-induced damage to the temperature sensors 36, 38 can be ruled out during the manufacture of the heat exchanger outer housing 28, during which the temperature sensors 38, 36 are also sealed in the heat exchanger outer housing at the same time.

It is apparent that the embedding of the temperature sensors in a housing part of the heat exchanger can also be achieved if, e.g., a housing already present in a vehicle shall be used for this purpose, so that the heater shall be integrated within an already existing housing, e.g., of a vehicle fan or a vehicle air conditioner.

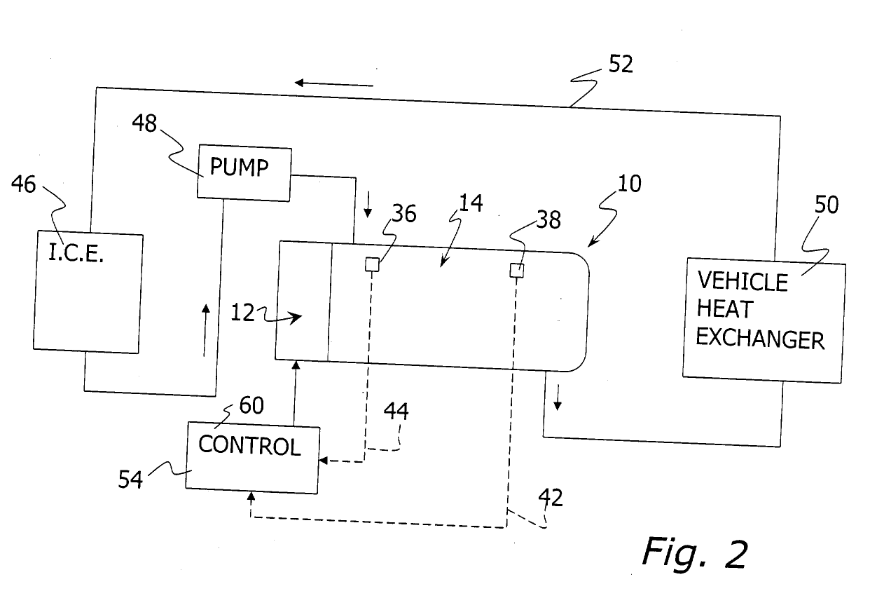

The heater 10 may be a part of a vehicle heater system as shown in FIG. 2. The vehicle internal combustion engine (I.C.E.) 46 may be connected to the vehicle heat exchanger 14 via fluid lines 52 and a pump 48. The vehicle heat exchanger 50 may be connected by these lines to the heat exchanger 14 of the heater 10. Other system configurations can be provided including bypass lines to bypass the I.C.E. 46 or to bypass the heat exchanger 50. The direction of fluid flow in FIG. 2 may be reversed and arrangements other than the circuit line 52 may be employed. Further embodiments of the system may utilize the heater 10 with total independence from the vehicle I.C.E. 46. The temperature sensor arrangement 34 may be connected to a control element 60 with temperature sensor 36 connected to control element 60 by line 44 and temperature sensor 38 connected to control element 60 by line 42. The burner control element 60 is connected to controllable aspects of the burner 12 such as a fuel feed, air intake, etc..

While a specific embodiment of the invention has been shown and described in detail to illustrate the application of the principles of the invention, it will be understood that the invention may be embodied otherwise without departing from such principles.

What is claimed is:

1. A heat exchanger arrangement for a vehicle heater, the heat exchanger arrangement comprising:
a housing element forming part of a housing arrangement with a fluid flow space surrounded by said housing arrangement;
a temperature sensor arrangement for detecting a variable related to the temperature of a fluid flowing through said fluid flow space, said temperature sensor arrangement comprising at least one temperature sensor at least partially integrated in the material of a housing element forming at least one part of the said housing arrangement.

2. A heat exchanger arrangement in accordance with claim 1, wherein said at least one temperature sensor is completely surrounded by the material of said housing element.

3. A heat exchanger arrangement in accordance with claim 1, wherein said at least one temperature sensor has a detection section protruding into said fluid flow space.

4. A heat exchanger arrangement in accordance with claim 1, wherein said housing element is made of a plastic material.

5. A heat exchanger arrangement in accordance with claim 1, wherein said housing element is made of fiber-reinforced polyamide or polypropylene.

6. A heat exchanger in accordance with claim 1, wherein said housing element is a pot-shaped heat exchanger outer housing defining an outer side of said fluid flow space.

7. A heat exchanger arrangement in accordance with claim 1, wherein said housing element is a housing element integrated into a heater.

8. A heat exchanger arrangement in accordance with claim 1, wherein said at least one temperature sensor is at least partially embedded in said housing element based on providing the material of said housing element at least partially around said at least one temperature senor during formation.

9. A vehicle heater system, comprising:
a heater with an engine independent burner and a heat exchanger connected to said burner and including a housing element forming part of a housing arrangement with a fluid flow space surrounded by said housing arrangement and a temperature sensor arrangement for detecting a variable related to the temperature of a fluid flowing through said fluid flow space, said temperature sensor arrangement comprising a temperature sensor at least partially integrated in the material of a housing element forming at least one part of the said housing arrangement.

10. A vehicle heater system in accordance with claim 9, wherein said temperature sensor is completely surrounded by the material of said housing element.

11. A vehicle heater system in accordance with claim 9, wherein said temperature sensor has a detection section protruding into said fluid flow space.

12. A vehicle heater system in accordance with claim 9, wherein said housing element is made of a plastic material.

13. A vehicle heater system in accordance with claim 9, wherein said housing element is made of fiber-reinforced polyamide or polypropylene.

14. A vehicle heater system in accordance with claim 9, wherein said housing element is a pot-shaped heat exchanger outer housing defining an outer side of said fluid flow space.

15. A vehicle heater system in accordance with claim 9, wherein said temperature sensor is at least partially embedded in said housing element based on providing the material of said housing element at least partially around said at least one temperature sensor during formation.

16. A vehicle heater system in accordance with claim 9, further comprising:
a vehicle heat exchanger connected to said heat exchanger of said heater; and
and a burner control element connected to said burner of said heater and connected to said temperature sensor arrangement.

17. A heat exchanger arrangement formed by the steps of:
forming a housing element as a molded part with a temperature sensor at least partially in the element before the material of the element sets to provide a housing element with the temperature sensor at least partially embedded in the housing element; and
forming a housing arrangement with the housing element with the embedded sensor to form a fluid flow space surrounded by said housing arrangement and with the temperature sensor for detecting a variable related to the temperature of a fluid flowing through said fluid flow space.

18. A heat exchanger arrangement in accordance with claim 17, wherein said temperature sensor is completely surrounded by the material of said housing element.

19. A heat exchanger arrangement in accordance with claim 17, wherein said at least one temperature sensor has a detection section protruding into said fluid flow space.

20. A heat exchanger arrangement in accordance with claim 17, wherein said housing element is made of fiber-reinforced polyamide or polypropylene and said housing element is a pot-shaped heat exchanger outer housing defining an outer side of said fluid flow space.
